(19) United States
(12) Patent Application Publication
(10) Pub. No.: US 2009/0286634 A1
(43) Pub. Date: Nov. 19, 2009

(54) CHAIN

(75) Inventor: Yoshiaki Takagishi, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/419,511

(22) Filed: Apr. 7, 2009

(30) Foreign Application Priority Data
May 16, 2008 (JP) 2008-129561

(51) Int. Cl. F16H 57/05

(52) U.S. Cl. 474/91

(57) ABSTRACT

In a roller chain or bushing chain, oil introducing holes in a bushing are offset laterally from a central location between the inner link plates, located in close proximity to the inner link plates, but not buried within the holes of the inner link plates in which the bushing is press-fit.

### CROSS-REFERENCE TO RELATED APPLICATION

This application claims priority on the basis of Japanese patent application 2008-129561, filed May 16, 2008. The disclosure of Japanese application 2008-129561 is hereby incorporated by reference.

### FIELD OF THE INVENTION

This invention relates to a chain for use in a power transmission, a conveying mechanism, or the like in such applications as automobile engines and industrial machinery. More specifically, it relates to a roller chain, or a rollerless bushing chain, in which alternating inner and outer links are connected by cooperating bushings and pins.

### BACKGROUND OF THE INVENTION

Roller chains and rollerless bushing chains are well known and widely used in a variety of applications. The typical chain is made up of alternating inner and outer links. Each inner link comprises a pair of inner link plates, and a pair of cylindrical bushings press-fit into bushing holes formed in the inner link plates and connecting the inner link plates in opposed, spaced, relationship. Each outer link comprises a pair of outer link plates. Each outer link plate has a pair of connecting pins press-fit into pin holes formed in the outer link plates and connecting the outer link plates in opposed, spaced, relationship. The inner links are disposed in alternating, overlapping relationship with the outer links, and each pin of each outer link extends rotatably through a bushing of an adjacent inner link, so that the inner and outer links are connected to form an elongated, articulating transmission medium, which is ordinarily formed as an endless loop for transmission of power from a driving sprocket to one or more driven sprockets.

It is also known to provide for introduction of lubricating oil into a clearance between a bushing and the connecting pin which extends through the bushing so that the chain can bend smoothly. Moreover it is also known to provide oil introducing holes in the bushings for more effective introduction of lubricating oil.

FIG. 7 shows an example of a bushing 512 having a centrally located oil introducing hole 515, which extends radially from the outer circumferential surface of the bushing to its inner circumferential surface.

FIG. 8 shows a part of a chain in which a bushing 612, provided with cut-out portions 616 at both ends and extending axially from its end surfaces, is press-fit into a bushing hole 613 of an inner link plate 611. The cut-out portions 616 extend inward past the inner faces of the link plates, thereby forming oil introducing holes 615.

The bushings of FIGS. 7 and 8 are described in Japanese Laid-open Patent Publication No. Hei. 10-238598.

In the case of a roller chain incorporating the bushing 512 of FIG. 7, since the oil introducing hole 515 in the bushing is disposed at a central location between the ends of the bushing, the oil introducing hole is covered by a roller, which inhibits the flow of oil through the oil introducing hole.

In case of a rollerless bushing chain incorporating the bushing 512 of FIG. 7, depending on the location of the oil introducing hole, when a bushing is press-fit into opposite inner link plates of the chain, it is possible for the oil introducing hole 515 to be positioned at the location at which the bushing contacts a sprocket. When the oil introducing hole is located so that it contacts the sprocket, noise and vibration can be generated in the operation of the chain. On the other hand, if steps are taken to position the bushings relative to the inner link plates so that their oil introducing holes cannot come into contact with a sprocket, assembly of the chain becomes excessively complicated.

In the case of the bushing 612 in FIG. 8, the cut-out portions 616 are located so that the rollers do not interfere with the flow of oil into the clearance between the roller and the connecting pin. However, the cut-out portions prevent the ends of the bushing from being securely fastened to the link plates by press-fitting.

This invention solves the above-described problems of the prior art. According to a first aspect of the invention, a chain is provided in which sufficient lubricating oil can be introduced into the clearances between the bushings and the connecting pins even in the case of a roller chain in which rollers are provided on the outer circumferences of the bushings. In accordance with another aspect of the invention, assembly of the chain is simplified by avoiding the necessity for controlling the direction of the oil introduction holes while securing the bushings to the link plates. In accordance with still another aspect of the invention, chain rollers do not interfere with adequate lubrication of the clearances between the bushings and the connecting pins, while the bushings are securely fastened by press-fitting in the link plates of the chain.

### SUMMARY OF THE INVENTION

The chain in accordance with the invention comprises inner and outer links disposed in alternating, overlapping relationship. Each inner link comprises a pair of inner link plates, and a pair of cylindrical bushings press-fit into bushing holes formed in the inner link plates and connecting the inner link plates of the pair in opposed, spaced, relationship. Each outer link comprises a pair of outer link plates, and a pair of connecting pins press-fit into pin holes formed in said outer link plates and connecting said outer link plates in opposed, spaced, relationship. Each pin of each outer link extends rotatably through a bushing of an adjacent inner link, whereby said inner and outer links are connected to form an elongated, articulating, transmission medium. Each bushing has an inner peripheral surface surrounding a connecting pin with a clearance, and an outer peripheral surface. At least one oil introducing hole is provided in each bushing, extending from the outer peripheral surface of the bushing to the inner peripheral surface thereof. The oil introducing hole in each bushing is located farther from one than from the other of the opposed inner link plates in which the bushing is press-fit, but the entire oil introducing hole is spaced from the other inner link plate of the pair so that the oil introducing hole is located adjacent said other of the opposed link plates, and no part of the oil introducing hole is within a bushing hole in said other of the opposed link plates.

If the chain is a roller chain, a roller is provided on each said bushing and rotatable thereon. Preferably each bushing is provided with at least two oil introducing holes, each extending from the outer peripheral surface of the bushing to the inner peripheral surface thereof. One of these two holes is closer to one of the link plates in which the bushing is press-fit than to the other of the link in which the bushing is press-fit, and the other of the two holes is closer to said other of the link plates in which the bushing is press-fit than to said one of the link plates in which the bushing is press-fit. Each of said two holes is spaced from the link plate to which it is closest, so that no part of the oil introducing hole is within a bushing hole in the link plate to which it is closest. The two holes are spaced from each other along the direction of the length of the bushing in which they are provided by a distance sufficient that the roller cannot cover all of both of the holes at the same time.

In certain preferred embodiments, the bushing is a plate formed into a cylinder with abutting end portions, and an oil introducing hole is constituted by a pair of semicircular grooves formed in abutting end portions of the plate, the grooves being in opposed relationship to each other.

In other embodiments, including any of the previously mentioned embodiments, an oil introducing hole can have a funnel-shaped portion, extending inward from the outer circumferential surface of the bushing in which it is formed, the diameter of the funnel shaped portion being greatest at the location of the outer circumferential surface of the bushing.

In still other embodiments, including any of the previously mentioned embodiments, an oil introducing hole can have its outer opening at the location of the outer circumferential surface of the bushing in which it is formed and its inner opening at the location of the inner circumferential surface of the bushing in which it is formed, and the oil introducing hole can be slanted so that its outer opening is closer than its inner opening to the nearest end of the bushing.

When the oil introducing hole is closer to one link plate of an opposed pair than to the other link plate, but not buried in the inner link plate hole in which the bushing is press-fit, sufficient lubricating oil can be introduced to the clearance between the connecting pin and the bushing even when a roller is present. The offset location of the oil introducing hole makes it possible to avoid contact between the hole and a sprocket, so that, during assembly of the chain, it is not necessary to take into account the rotational position of the bushing relative to the inner link plates in which it is press-fit. Moreover, since the oil introducing hole is not buried in the inner link plate hole in which the bushing is press-fit, there is no weakening of the press-fit connection of the bushing to the link plate.

In the case of a roller chain in which the bushing has two holes spaced from each other by a distance such that the roller cannot cover all of both of said holes at the same time. Moreover, even if the roller is biased toward one of the inner link plates the decrease in the aperture of one of the holes is balance by an increase in the aperture of the other hole, so that an adequate flow of lubricating hole to the clearance between the bushing and the connecting pin can be maintained.

When the bushing is a plate formed into a cylinder with abutting end portions, and one or more oil introducing holes are each constituted by a pair of semicircular grooves formed in abutting end portions of the plate, the grooves forming each hole being in opposed relationship to each other, the bushing and its oil introducing hole or holes can be easily formed with accuracy.

A funnel shaped outer opening of an oil introducing hole improves the ability of the hole to conduct a sufficient amount of lubricating oil to the clearance between the bushing and the connecting pin. An inwardly slanted oil introducing hole, i.e., one having its outer opening near an inner link plate and its inner opening farther away from the inner link plate, also improves the ability of the hole to conduct lubricating oil to the clearance between the bushing and the connecting pin.

### BRIEF DESCRIPTION OF THE DRAWINGS

FIG. 1 is an exploded perspective view of a part of a chain, in accordance with the invention;

FIG. 2 is a cross-sectional view of a part of the chain, taken on a plane parallel to the direction of elongation of the chain;

FIG. 3 is a cross-sectional view of a part of the chain, taken on a plane perpendicular to the direction of elongation of the chain;

FIGS. 4(a), 4(b), 4(c) and 4(d) are schematic views showing sequential stages in the manufacture of a bushing according to the invention;

FIG. 5 is a cross-sectional view of a part of an inner link of a chain according to a second embodiment of the invention, taken on a plane parallel to the direction of elongation of the chain;

FIG. 6 is a cross-sectional view of a part of an inner link of a chain according to a third embodiment of the invention, taken on a plane parallel to the direction of elongation of the chain;

FIG. 7 is a perspective view of a bushing of a conventional chain; and

FIG. 8 is a perspective view of a bushing of another conventional chain, also showing a portion of an inner link plate into which the bushing is press-fit.

### DETAILED DESCRIPTION OF THE PREFERRED EMBODIMENTS

The advantages of the chain according to the invention, in which the oil introducing hole or holes in a bushing are offset laterally from a central location between the inner link plates, but not buried within the inner link plates, can be realized in any of a wide variety of embodiments, and in various applications including, for example, the timing drive of an automobile engine, a drive for an auxiliary engine component such as an oil pump, and other power transmission mechanisms such as conveyors and the like. Advantages of the invention can be realized not only in roller chains, but also in rollerless bushing chains.

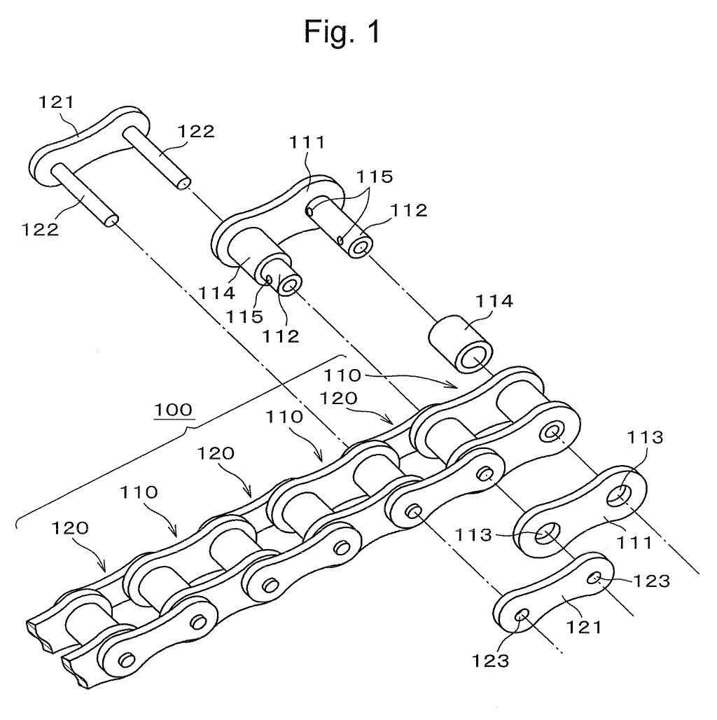

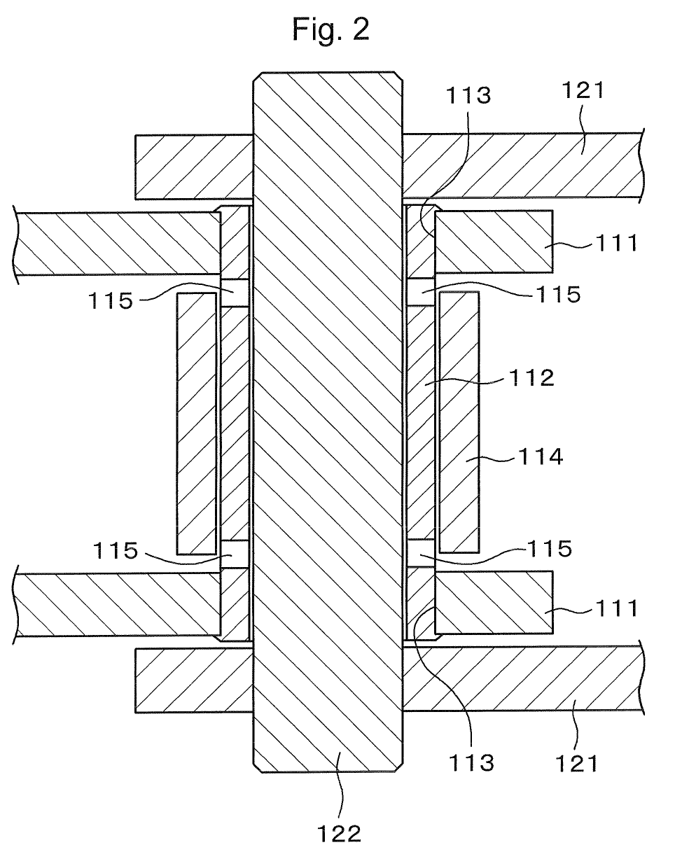

As shown in FIGS. 1 and 2, the chain 100, is composed of inner links 110 and outer links 120 arranged alternately along the length of the chain. Each inner link 110 is composed of a pair of right and left inner link plates 111, each having front and rear holes 113 in which cylindrical bushings 112 are press-fit. In the case of a roller chain, rollers 114 are provided, and are rotatable on the bushings 112.

Each outer link 120 is composed of a pair of right and left outer link plates 121, each having front and rear pin holes 123 in which connecting pins 122 are press-fit.

Each of the two connecting pins of an outer link 121 extends rotatably through a bushing of one of the two adjacent inner links, thereby connecting the inner and outer links to one another in an alternating arrangement, forming the chain 120.

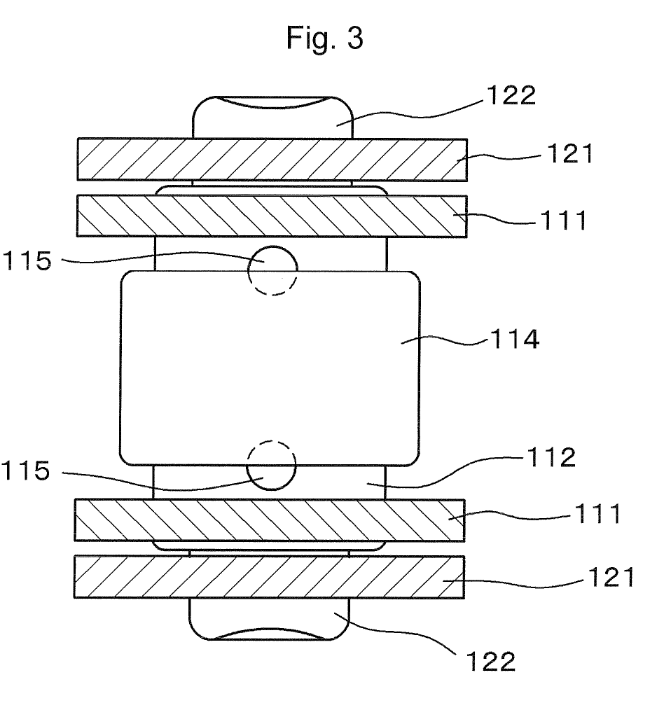

The bushing 112 has oil introducing holes 115, which extend from the outer circumferential surface of the bushing to its inner circumferential surface. As shown in FIG. 2, These oil introducing holes 115 are positioned in close proximity to the inner link plates 111 and the holes 113 in which the bushing is press-fit. However, the oil introducing holes are not buried in the pin holes 113. That is, as shown in FIGS. 2 and 3, no part of any of the oil introducing holes 115 is within a link plate hole in which a bushing is press-fit.

A roller 114 is provided on the outer circumference of the bushing 112 and rotatable thereon. The axial length of the roller 114 is less than the distance between the opposite inner link plates 114 and less than the axial distance between the parts of the two axially spaced holes 115 that are closest to the respective inner link plates. Thus, although a small amount of axial movement of the roller along the bushing can occur, the roller cannot all of both of holes 115 at the same time, and at least a part of at least one of the oil introducing holes 115 is uncovered at all times.

Since no parts of the oil introducing holes 115 are located within the holes 113 into which the bushings are press-fit, the secure connection of the bushings to the inner link plates is not diminished. Moreover, even if the roller 114 moves toward one of or the other of the opposed inner link plates 111 partially or fully covering one or the other of the oil introducing holes, the amount by which the aperture of one hole is decreased is balanced by a corresponding increase in the aperture of the opposite hole. Consequently, axial movement of the roller along the bushing 112 does not significantly decrease the supply of oil to the clearance between the bushing 112 and the connecting pin 122.

In the case of a bushing chain having no roller 114, the positioning of the oil introducing holes 115 in close proximity to the inner link plates has the advantage that the oil introducing holes are remote from the central portion of the bushing where they could come into contact with a sprocket, and there is need to take special measures to secure the bushing in the inner link plates so that the oil introducing holes are located so that they cannot contact the sprocket teeth. The positioning of the oil introducing holes 115 in close proximity to the inner link plates also allows oil introducing holes to be provided at plural locations around the perimeter of the bushing.

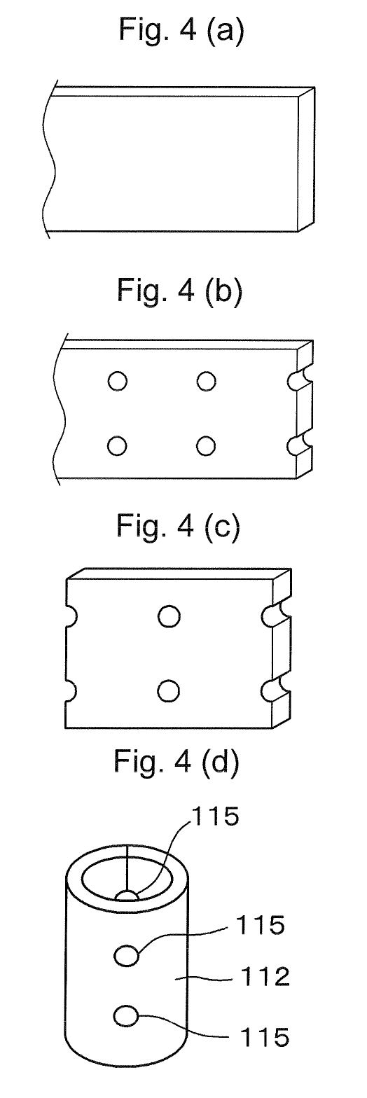

In the manufacture of the bushing, a metal strip (FIG. 4(a)) is first subjected to a drilling or stamping operation by which holes (FIG. 4(b)) are produced at predetermined intervals. The metal strip is then cut along the center line of a set of holes to obtain a plate having semicircular grooves formed at both ends (FIG. 4(c)).

The plate is then wound into a cylinder so that the semicircular grooves on both ends meet, as shown in FIG. 4(d) forming oil introducing holes. The cylindrical bushing shown in FIG. 4(d) has oil introducing holes formed by meeting semicircular grooves, and also has additional oil introducing holes formed by stamping or drilling.

Because the holes are formed as a first step in a flat strip before cutting the strip into plates and winding the plates into cylinders, the holes can be produced easily, in any desired number, and at any desired location, without impairing the roundness of the bushing.

In the bushing 212, shown in FIG. 6 the oil introducing holes 215, which extend from the outer circumferential surface of the bushing to its inner circumferential surface, have tapered, funnel-shaped, portions 216 at their outer ends. The diameter of each funnel-shaped portion is greatest at the location of the outer periphery of the bushing.

As in the case of the previously describe embodiment, the oil introducing holes are in close proximity to the holes 213 of the inner link plates 211, in which the bushing is press-fit, but no part of the oil introducing holes is within a hole in which the bushing is press-fit.

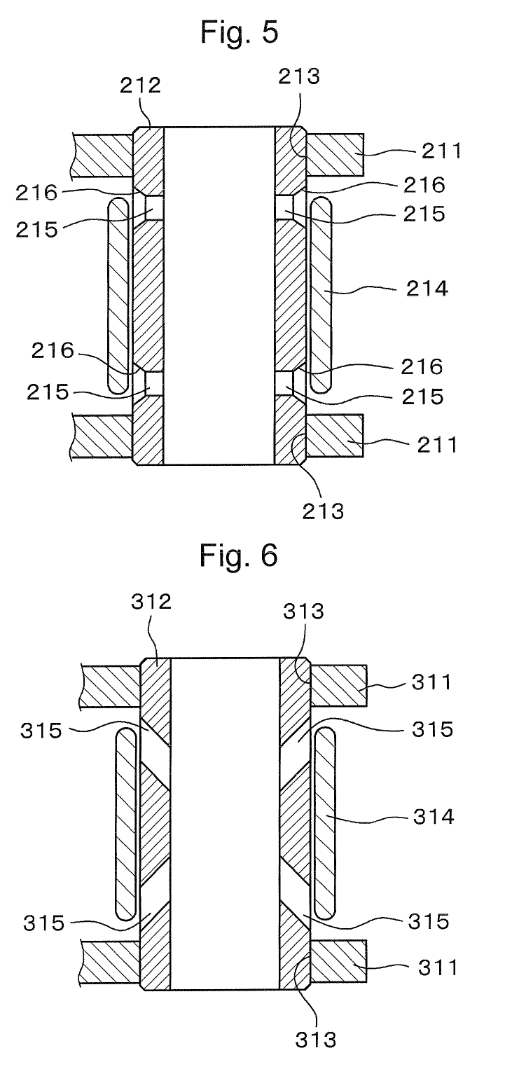

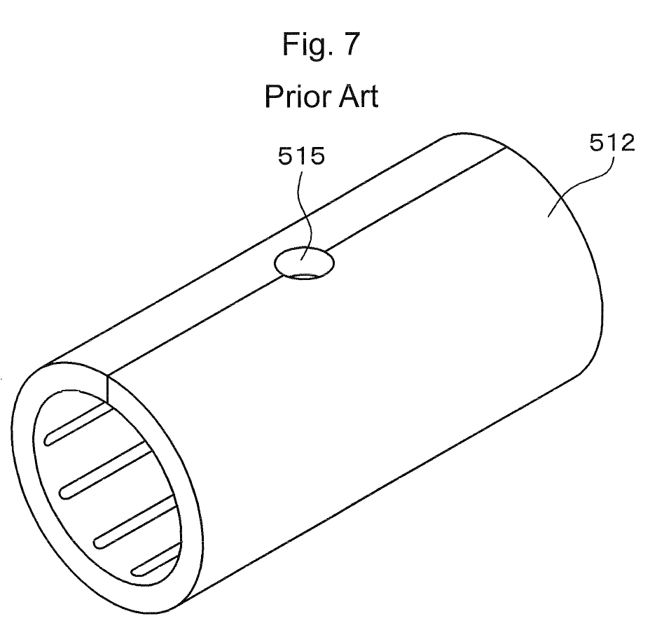

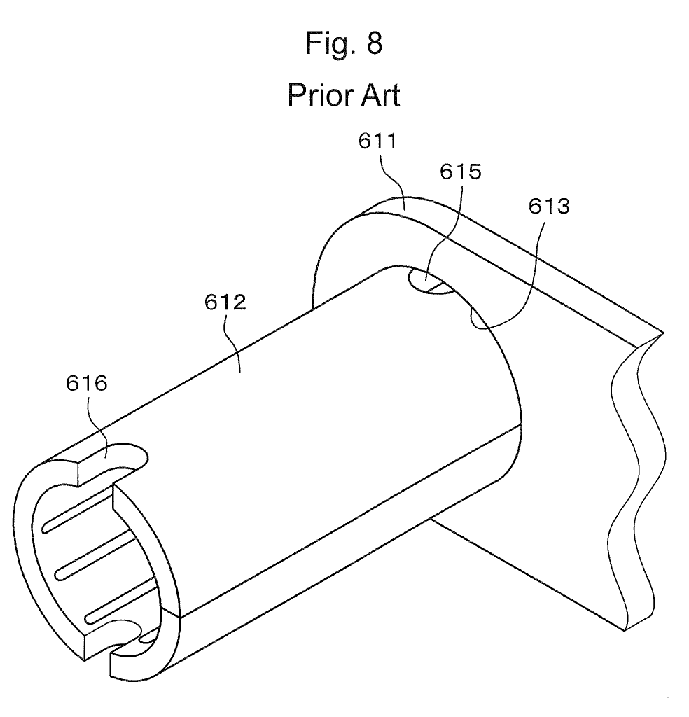

The funnel shaped portions of the oil introducing holes allow oil, collected through the spaces between the ends of the roller 214 and the inner link plates, to flow more freely into the clearance between the bushing 212 and the connecting pin (not shown in FIG. 5). Here, as in the previously described embodiment, the roller 214 has some freedom to slide axially along the bushing, but the outer openings of the oil introducing holes, that is, the large diameter ends of the funnel-shaped portions of the holes, are located so that the roller cannot cover the openings adjacent one inner link plate while simultaneously covering the openings adjacent the opposite link plate.

The bushing 312, shown in FIG. 6, also has oil introducing holes 315, which extend from the outer circumferential surface of the bushing to its inner circumferential surface. Here, as in the previously described embodiments, the outer ends of the holes 315 are in close proximity to the holes 313 of the inner link plates 311, in which the bushing is press-fit, but no part of the oil introducing holes is within a hole in which the bushing is press-fit.

As shown in FIG. 6, the oil introducing holes are slanted so that their outer ends are closer than their inner ends to the adjacent inner link plates.

As in the previously described embodiments, the roller 314 can slide axially along the bushing through a short distance, but the outer openings of the oil introducing holes, are located so that the roller cannot cover the openings adjacent one inner link plate while simultaneously covering the openings adjacent the opposite link plate.

The slanted oil introducing holes carry lubricating oil to a central location within the clearance between the bushing and the connecting pin (not shown) extending through the bushing, thereby ensuring adequate lubrication of the central portion of the clearance.

In a chain according to the invention, sufficient lubricating oil can be introduced into the clearance between a bushing and a connecting pin, even when a roller is provided on the outer circumference of the bushing. Assembly of the chain is easy especially because it is unnecessary to take into account the direction of the oil introducing holes when press-fitting the bushing into the inner link plates. Moreover, the press-fit relationship between the bushing and the inner link plates is secure.

Although in the embodiments described above, two oil introducing holes are provided adjacent each end of a bushing, the number of oil introducing holes can vary. For example, the bushing can have one oil introducing hole at each end, or three or more oil introducing holes at each end. Furthermore, it is unnecessary to have the same number of oil introducing holes at both ends. Although it is desirable, especially in the case of a roller chain, to have oil introducing holes adjacent both ends of a bushing, some of the advantages of the invention can be obtained even if the oil introducing hole or holes are provided only adjacent one end of the bushing. The oil-introducing holes, of course, can have any suitable diameter.

I claim:

1. A chain comprising inner and outer links, each inner link comprising a pair of inner link plates, and a pair of cylindrical bushings press-fit into bushing holes formed in said inner link plates and connecting said inner link plates of said pair in opposed, spaced, relationship, each outer link comprising a pair of outer link plates, and a pair of connecting pins press-fit into pin holes formed in said outer link plates and connecting said outer link plates of said pair of outer link plates in opposed, spaced, relationship, the inner links being disposed in alternating, overlapping relationship with said outer links, and each pin of each outer link extending rotatably through a bushing of an adjacent inner link, whereby said inner and outer links are connected to form an elongated, articulating transmission medium, each said bushing having an inner peripheral surface surrounding a connecting pin with a clearance, and an outer peripheral surface, and at least one oil introducing hole in each bushing, in which the oil introducing hole extends from the outer peripheral surface of the bushing to the inner peripheral surface thereof and is located farther from one than from the other of the opposed inner link plates in which the bushing is press-fit, but the entire oil introducing hole is spaced from said other of the inner link plates, whereby the oil introducing hole is located adjacent said other of the opposed link plates, and no part of the oil introducing hole is within a bushing hole in said other of the opposed link plates.

2. A chain according to claim 1, having a roller rotatable on each said bushing, and in which each said bushing is provided with at least two oil introducing holes, each extending from the outer peripheral surface of the bushing to the inner peripheral surface thereof, one of said two holes being closer to one of the link plates in which the bushing is press-fit than to the other of said link plates in which the bushing is press-fit, and the other of said two holes being closer to said other of the link plates in which the bushing is press-fit than to said one of said link plates in which the bushing is press-fit, in which each of said two holes is spaced from the link plate to which it is closest whereby no part of the oil introducing hole is within a bushing hole in the link plate to which it is closest, and in which said two holes are spaced from each other along the direction of the length of the bushing in which they are provided by a distance sufficient that the roller cannot cover all of both of said holes at the same time.

3. A chain according to claim 1, in which said bushing is a plate formed into a cylinder with abutting end portions, and in which said oil introducing hole is constituted by a pair of semicircular grooves formed in abutting end portions of said plate, said grooves being in opposed relationship to each other.

4. A chain according to claim 2, in which said bushing is in a plate formed into a cylinder with abutting end portions, and in which each said oil introducing hole is constituted by a pair of semicircular grooves formed in abutting end portions of said plate, said grooves being in opposed relationship to each other.

5. A chain according to claim 1, in which said oil introducing hole has a funnel-shaped portion, extending inward from the outer circumferential surface of the bushing in which it is formed, the diameter of the funnel shaped portion being greatest at the location of the outer circumferential surface of said bushing.

6. A chain according to claim 2, in which each of said oil introducing holes has a funnel-shaped portion, extending inward from the outer circumferential surface of the bushing in which it is formed, the diameter of the funnel shaped portion being greatest at the location of the outer circumferential surface of said bushing.

7. A chain according to claim 3, in which said oil introducing hole has a funnel-shaped portion, extending inward from the outer circumferential surface of the bushing in which it is formed, the diameter of the funnel shaped portion being greatest at the location of the outer circumferential surface of said bushing.

8. A chain according to claim 4, in which each of said oil introducing holes has a funnel-shaped portion, extending inward from the outer circumferential surface of the bushing in which it is formed, the diameter of the funnel shaped portion being greatest at the location of the outer circumferential surface of said bushing.

9. A chain according to claim 1 in which said oil introducing hole has an outer opening at the location of the outer circumferential surface of the bushing in which it is formed and an inner opening at the location of the inner circumferential surface of the bushing in which it is formed, and in which the outer opening is closer than the inner opening to the nearest end of said bushing.

10. A chain according to claim 2, in which each said oil introducing hole has an outer opening at the location of the outer circumferential surface of the bushing in which it is formed and an inner opening at the location of the inner circumferential surface of the bushing in which it is formed, and in which the outer opening is closer than the inner opening to the nearest end of said bushing.

11. A chain according to claim 3, in which said oil introducing hole has an outer opening at the location of the outer circumferential surface of the bushing in which it is formed and an inner opening at the location of the inner circumferential surface of the bushing in which it is formed, and in which the outer opening is closer than the inner opening to the nearest end of said bushing.

12. A chain according to claim 4, in which each said oil introducing hole has an outer opening at the location of the outer circumferential surface of the bushing in which it is formed and an inner opening at the location of the inner circumferential surface of the bushing in which it is formed, and in which the outer opening is closer than the inner opening to the nearest end of said bushing.
